(19) United States
(12) Patent Application Publication
(10) Pub. No.: US 2017/0070740 A1
(43) Pub. Date: Mar. 9, 2017

(54) ENCODING TECHNIQUES FOR DISPLAY OF TEXT AND OTHER HIGH-FREQUENCY CONTENT

(71) Applicant: INTEL CORPORATION, SANTA CLARA, CA (US)

(72) Inventors: Sean J. Lawrence, Bangalore (IN); Raghavendra Angadimani, Bangalore (IN)

(73) Assignee: INTEL CORPORATION, SANTA CLARA, CA (US)

(21) Appl. No.: 14/844,291

(22) Filed: Sep. 3, 2015

(51) Int. Cl. H04N 19/186; H04N 19/44; H04N 19/86; H04N 19/146; H04N 19/423; H04N 19/70; H04N 19/132; H04N 19/136; H04N 5/38

(52) U.S. Cl. CPC H04N 19/186; H04N 19/136; H04N 19/44; H04N 19/86; H04N 5/38; H04N 19/423; H04N 19/70; H04N 19/132; H04N 19/146

(57) ABSTRACT

Techniques are disclosed for combining sub-sampled chroma samples across multiple frames to include all color information for a given scene. In accordance with some embodiments, each frame may be encoded such that it contains different color samples in a sub-sampled color format. A sliding window across the desired number of frames, which can be varied based on the level of sub-sampling, may select the frames with the sub-sampled color data to be used for combination to recreate the scene with all color information, in accordance with some embodiments. The disclosed techniques can be used, for example, in the transfer and rendering of streaming or stored compressed video content that includes text. To such ends, the disclosed techniques can be used in any one, or combination, of RGB-YUV conversion, video encoding, and video frame combination. More generally, the disclosed techniques can be utilized in video content creation, as well as consumption.

### BACKGROUND

Chrominance, sometimes called chroma, generally refers to the signal used in video systems to convey color information of a given image and is typically paired with a luma signal that represents the brightness in the image (i.e., black-and-white, or achromatic portion of the image). Chroma sub-sampling can be used in encoding images and video signals. In chroma sub-sampling, chroma information is encoded at a lower resolution than luma information. In general, human eyes have lower acuity for differences in color than for differences in luminance. Thus, by encoding an image or video with chroma sub-sampling, the signal can be compressed or otherwise reduced in size, freeing up bandwidth, with only negligible or otherwise minimally perceivable loss of the color information. The so-called YUV color space utilizes chroma sub-sampling, allowing for reduced bandwidth for chrominance components in an image or video signal.

### BRIEF DESCRIPTION OF THE DRAWINGS

FIG. 1 illustrates an example data flow for streaming video content, in accordance with an embodiment of the present disclosure.

FIGS. 2A-2D illustrate example sub-sampling format layouts of several consecutive frames for YUV 4:2:0 conversion, in accordance with an embodiment of the present disclosure.

FIG. 3 illustrates conversion of several consecutive YUV 4:2:0 frames to an example YUV 4:4:4 frame, in accordance with an embodiment of the present disclosure.

FIG. 4 illustrates video encoding of several example YUV 4:2:0 frames for bitstream compliance, in accordance with an embodiment of the present disclosure.

FIG. 5 illustrates video decoding of several example YUV 4:2:0 frames for bitstream compliance, in accordance with an embodiment of the present disclosure.

FIG. 6 illustrates combination of example chroma sub-sampled YUV frames via a sliding window to produce a YUV 4:4:4 sampled frame, in accordance with an embodiment of the present disclosure.

FIG. 7 illustrates an example data flow for stored video content, in accordance with an embodiment of the present disclosure.

FIG. 8 illustrates combination of example chroma sub-sampled YUV frames via a sliding window to produce a YUV 4:4:4 sampled frame, in accordance with an embodiment of the present disclosure.

FIG. 9 is a block diagram illustrating an example computing device configured in accordance with an embodiment of the present disclosure.

FIG. 10A is an enlarged view of 8-pt. red text on a green background after typical chroma 4:2:0 sub-sampled encoding and decoding.

FIG. 10B is an enlarged view of 8-pt. red text on a green background after YUV 4:4:4 conversion by YUV 4:2:0 frame combination encoding and decoding, in accordance with an embodiment of the present disclosure.

FIG. 11 illustrates an example system that may carry out the techniques for video content encoding and decoding as described herein, in accordance with some embodiments.

FIG. 12 illustrates embodiments of a small form factor device in which the system of FIG. 11 may be embodied.

### DETAILED DESCRIPTION

Image encoding techniques are disclosed for display of text and other high-frequency content. In an embodiment, the techniques include combining sub-sampled chroma samples across multiple frames to include all color information for a given scene. In some such cases, each frame is encoded such that it contains different color samples in a sub-sampled color format. A sliding window across the desired number of frames, which can be varied based on the level of sub-sampling, selects the frames with the sub-sampled color data to be used for combination to recreate the scene with all color information, in accordance with some embodiments. The disclosed techniques can be used, in accordance with some embodiments, in the transfer and rendering of streaming or stored compressed video content that includes text. To such ends, the disclosed techniques can be used in any one, or combination, of RGB-YUV conversion, video encoding, and video frame combination. In a more general sense, the disclosed techniques can be utilized on the video content creation side, such as with a transmitter, encoder, or storage, on the video content consumption side, such as with a receiver, decoder, or reader, or a combination of any thereof. Numerous configurations and variations will be apparent in light of this disclosure.

General Overview

Chroma sub-sampling encoder schemes such as YUV 4:2:0 and YUV 4:2:2 have sub-optimal quality for images and videos that have high-frequency content due to color information sub-sampling. This is particularly noticeable, for instance, for content that contains colored text due to the sub-sampling at the text borders with noticeable artifacts on the constant-colored background and text. For applications such as WiDi and Miracast and other wireless display and docking protocols, this is a particular problem due to use of YUV 4:2:0 encoders for display of text and other similar high-frequency content. Use of higher chroma sampling formats such as YUV 4:4:4 significantly increases bandwidth requirements and is expensive in terms of encode and decode processing due to the larger amounts of data. To counter this bandwidth increase, the frame rate can be reduced, but when content resumes to changing quickly, the lowered frame rate may not be able to keep up, resulting in sub-optimal viewing experience during conversion from the lower frame rate to the higher frame rate due to the presence of playback artifacts.

Thus, and in accordance with some embodiments of the present disclosure, techniques are disclosed for combining sub-sampled chroma samples across multiple frames to include all color information for a given scene. In accordance with some such embodiments, each frame is encoded such that it contains different color samples in a sub-sampled color format. A sliding window across the desired number of frames, which can be varied based on the level of sub-sampling, selects the frames with the sub-sampled color data to be used for combination to recreate the scene with all color information, in accordance with some embodiments. The disclosed techniques can be used, in accordance with some embodiments, in the transfer and rendering of streaming or stored compressed video content that includes text. To such ends, the disclosed techniques can be used in any one, or combination, of RGB-YUV conversion, video encoding, and video frame combination. In a more general sense, the disclosed techniques can be utilized on the video content creation side, such as with a transmitter, encoder, or storage, on the video content consumption side, such as with a receiver, decoder, or reader, or a combination of any thereof.

In accordance with some embodiments, the disclosed techniques may be utilized while maintaining bandwidth requirements and avoiding frame rate conversion (e.g., maintaining a constant frame rate), contrary to existing approaches. In some instances, the disclosed techniques may be utilized while maintaining bitstream compliance. Thus, techniques disclosed herein and devices that implement them may be wholly or otherwise sufficiently compatible with existing devices and systems that do not implement such techniques, allowing for seamless integration into existing wired and wireless systems. The disclosed techniques provide for inclusion and display of all color information for content that does not change quickly, such as static and relatively slow-moving or slow-changing content. In some instances, use of the disclosed techniques may provide for good quality text in slow-moving content, while maintaining a constant frame rate and a lower-bitrate compressed stream.

Techniques disclosed herein can be used in any of a wide range of target applications and end-uses, such as wireless display and wireless docking, among others, and in any of a wide range of contexts (e.g., enterprise; educational). In some instances, the disclosed techniques may be implemented in WiDi-enabled systems and Miracast-enabled systems. Numerous suitable uses of the disclosed techniques will be apparent in light of this disclosure.

In accordance with some embodiments, use of the disclosed techniques may be detected, for example, by visual inspection or reverse engineering with observance of any one or more of the following: (1) use of mixed sub-sampled chroma formats in encoded video streams; (2) use of a sliding window for frame combination and creation during decode; (3) chroma upsampling to YUV 4:2:2 or YUV 4:4:4; and (4) maintenance of frame rate and bandwidth with improved color quality as compared to standard format video streams.

Streaming Video Content Techniques

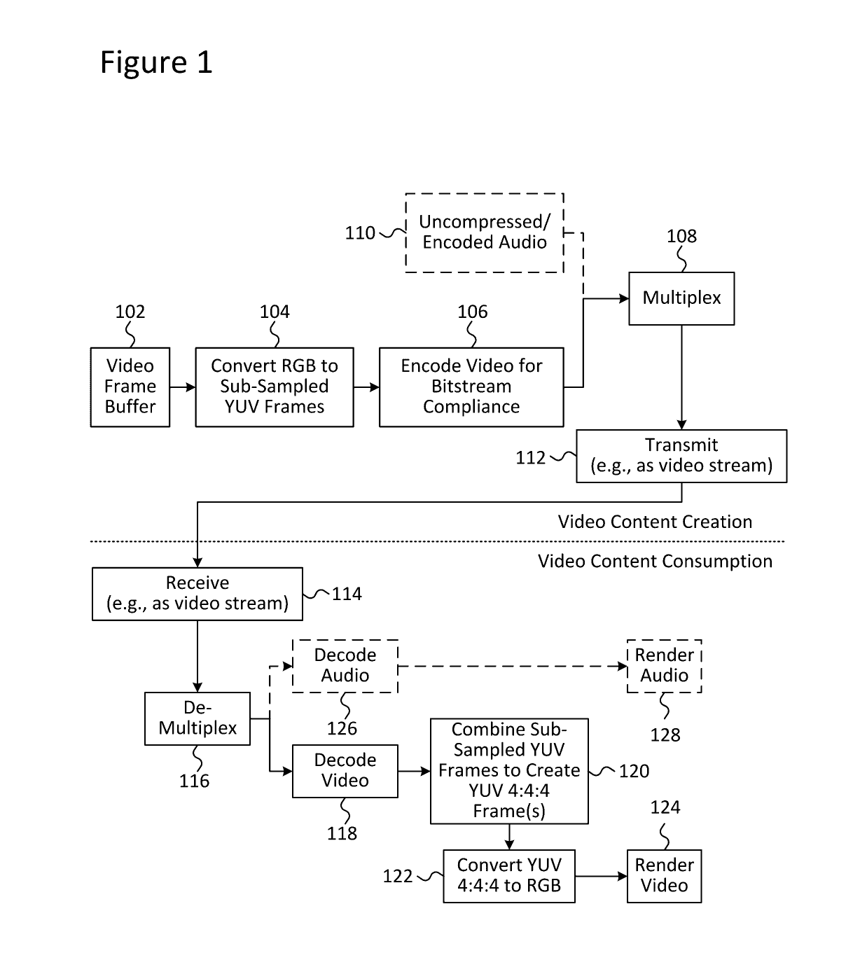

FIG. 1 illustrates an example data flow for streaming video content, in accordance with an embodiment of the present disclosure. As can be seen, the portion of the figure above the dotted line generally pertains to the creation (e.g., conversion; encoding; transmission) side of video content streaming, and the portion of the figure below the dotted line generally pertains to the consumption (e.g., reception; decoding; conversion) side of video content streaming. As will be appreciated in light of this disclosure, streaming video content creation may be performed, in part or in whole, by a wireless transmitter device (or wireless transceiver device having both transmitting and receiving capabilities). As will be further appreciated, streaming video content consumption may be performed, in part or in whole, by a wireless receiver device (or wireless transceiver device having both transmitting and receiving capabilities). Example devices include those that are any one, or combination, of WiDi-enabled, Miracast-enabled, and WiDock-enabled.

In accordance with some embodiments, a computing device 500 (discussed below) may have either or both video creation and consumption capabilities. In an example case, a first computing device 500 may transmit the video content, and a second computing device 500 may receive the video content. In accordance with some other embodiments, a network 400 (discussed below) may have either or both video creation and consumption capabilities. In an example case, a network 400 may transmit the video content, and a computing device 500 may receive the video content. In some cases, creation and consumption of video content may occur via a single device or at a single location, whereas in other cases, creation may occur via a first device or at a first location, and consumption may occur via a second device or at a second location. It should be noted, however, that these examples are intended to be non-limiting, as the disclosed techniques can be used in any of a wide range of contexts and applications using any of a wide range of components in any one, or combination, of software, firmware, and hardware, in accordance with some embodiments.

Looking first at the video content creation side of FIG. 1, video data from a video frame buffer 102 may undergo conversion 104 from red-green-blue (RGB) frames to sub-sampled YUV frames. In accordance with an embodiment, conversion 104 may be performed, in part or in whole, via an RGB-YUV conversion module 570 (discussed below). In an example case, the converted YUV frames 104 may be YUV 4:2:0 format. In another example case, the converted YUV frames 104 may be YUV 4:2:2 format. The present disclosure is not so limited, however, as in a more general sense, and in accordance with other embodiments, any suitable sub-sampling format may be utilized, as desired for a given target application or end-use.

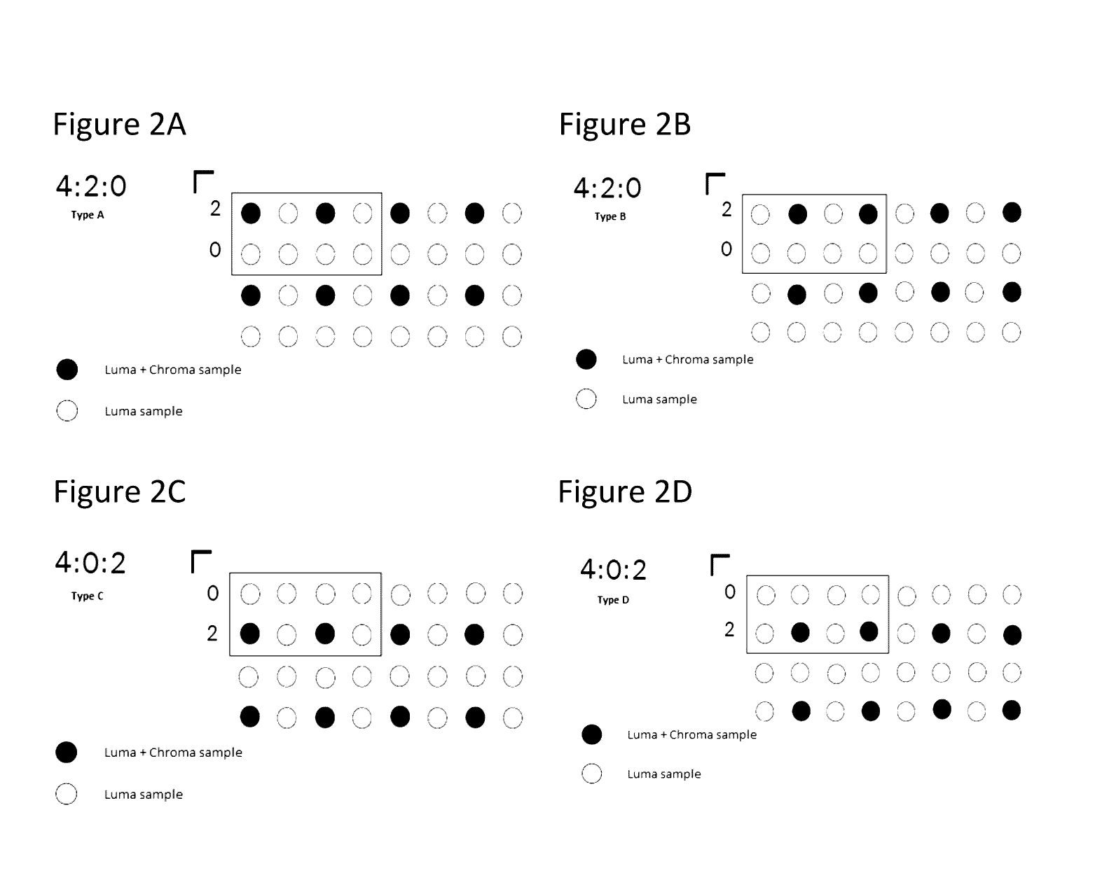

FIGS. 2A-2D illustrate example sub-sampling format layouts of several consecutive frames for YUV 4:2:0 conversion, in accordance with an embodiment of the present disclosure. FIGS. 2A-2D illustrate YUV 4:2:0 frame Types A, B, C, and D, respectively. As will be appreciated in light of this disclosure, even though these YUV 4:2:0 Types A-D frames are individually sub-sampled, over a series of consecutive frames, the sub-sampled color format will include all color samples when combined, provided that the scene information in each frame does not change (or only negligibly changes) across the constituent frames.

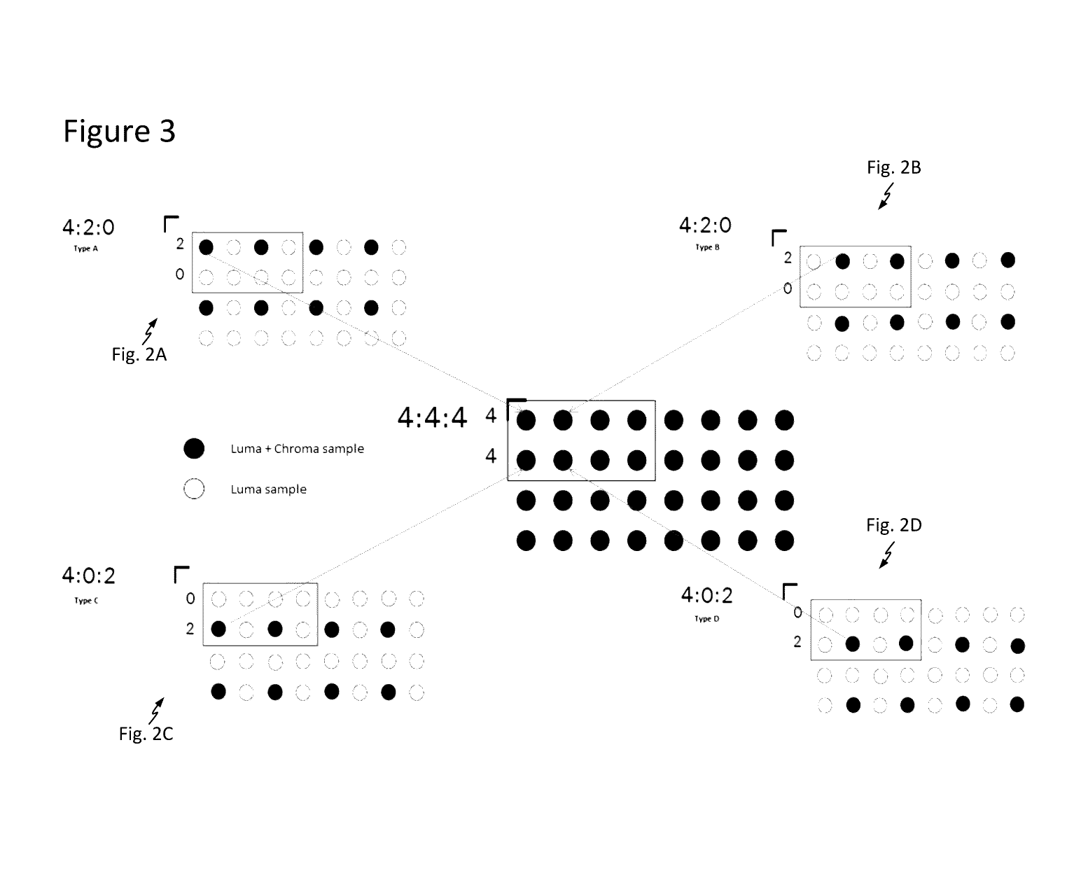

FIG. 3 illustrates conversion of several consecutive YUV 4:2:0 frames to an example YUV 4:4:4 frame, in accordance with an embodiment of the present disclosure. As can be seen, four sub-sampled frames may be sufficient for conversion from YUV 4:2:0 (FIGS. 2A-2D) to YUV 4:4:4 (FIG. 3). Each YUV 4:2:0 frame encodes ¼ of the total color information encoded by YUV 4:4:4. As will be appreciated in light of this disclosure, for conversions from other sub-sampled formats to YUV 4:4:4, greater or lesser quantities of sub-sampled frames may be sufficient, depending on the fraction of the total color information encoded in each constituent sub-sampled frame.

In the first 2×2 matrix of four sets of luma and chroma samples in FIGS. 2A-2D: (1) Type A (FIG. 2A) has chroma samples in position (1,1) only; (2) Type B (FIG. 2B) has chroma samples in position (1,2) only; (3) Type C (FIG. 2C) has chroma samples in position (2,1) only; and (4) Type D (FIG. 2D) has chroma samples in position (2,2) only. In accordance with an embodiment, combining this set of four chroma samples will allow for creating a frame with chroma samples in all four positions in this 2×2 matrix, as generally shown via the example YUV 4:4:4 frame format in the center of FIG. 3. Hence, conversion from a YUV 4:2:0 format to a YUV 4:4:4 format across a set of four frames can be achieved, provided that the content does not change (or only negligibly changes) across the sub-sampled frames.

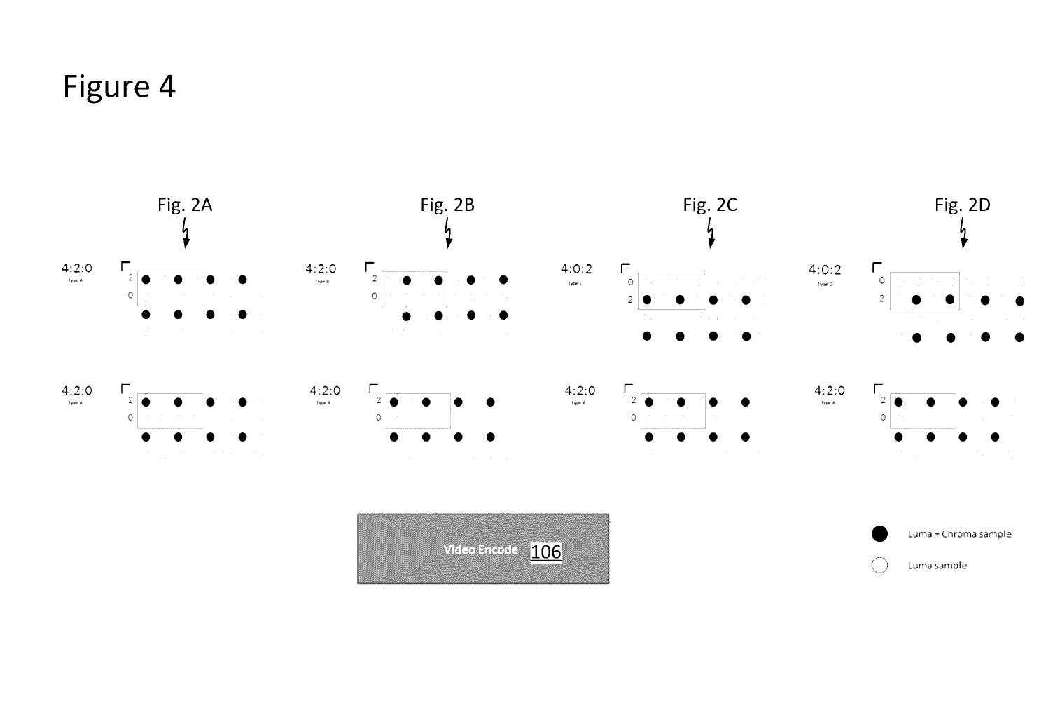

Returning to FIG. 1, after conversion 104, the resultant sub-sampled YUV frames may be encoded 106 for bitstream compliance. In accordance with some embodiments, encoding 106 may be performed, in part or in whole, via an encoder 582 (discussed below). As will be appreciated in light of this disclosure, in encoding 106, color information is typically expected from a single sampling position. Thus, it may be desirable to rearrange the color information of the sub-sampled YUV frames after conversion 104 to a single sampling position prior to encoding 106. For instance, consider FIG. 4, which illustrates video encoding of several example YUV 4:2:0 frames for bitstream compliance, in accordance with an embodiment of the present disclosure. As can be seen here, the color information of the example YUV 4:2:0 sub-sampled frames of FIGS. 2A-2D is rearranged to the top-left sampling position, though it should be noted that the present disclosure is not intended to be limited only to this example case, as any sampling position may be utilized, as desired for a given target application or end-use. In accordance with some embodiments, pre-encoding rearrangement may be performed, for example, via an RGB-YUV conversion module 570 (discussed below). In accordance with some other embodiments, pre-encoding rearrangement may be performed, for example, via a graphics processing unit (GPU) or other suitable processor 520 (discussed below). Other suitable means for performing sampling position rearrangement and encoding will depend on a given application and will be apparent in light of this disclosure.

The encoded video data 106 then may undergo multiplexing 108. In accordance with some embodiments, multiplexing 108 may be performed, for example, via a multiplexer 584 (discussed below). If uncompressed or encoded audio data is also present, then it optionally may be multiplexed 108 with the encoded video, in accordance with an embodiment.

Thereafter, the resultant multiplexed video (and optionally audio) may be provided for transmission 112 (e.g., as a video stream) or other output, as desired. In accordance with some embodiments, transmission 112 may be performed via a computing device 500, a network 400, or other transmitter (or transceiver having both transmitting and receiving capabilities), such as, for example, a WiFi or network transmitter stack or any other suitable wireless communication device, as desired for a given target application or end-use.

Turning now to the video content consumption side of FIG. 1, video data (e.g., a video stream) may be received 114 for de-multiplexing 116. In accordance with some embodiments, reception 114 may be performed via a computing device 500, a network 400, or other receiver (or transceiver having both transmitting and receiving capabilities), such as, for example, a WiFi or network receiver stack or any other suitable wireless communication device, as desired for a given target application or end-use.

In accordance with some embodiments, de-multiplexing 116 of the video (and optionally any uncompressed or encoded audio data 110, if present) may be performed via a de-multiplexer 594 (discussed below). In cases where audio data is present, it subsequently may undergo decoding 126 via a decoder 592 (discussed below) and rendering 128 via an audio output device 560 (discussed below). As will be appreciated in light of this disclosure, rendering 128 of audio data may be performed substantially simultaneously with rendering 124 of video data (discussed below).

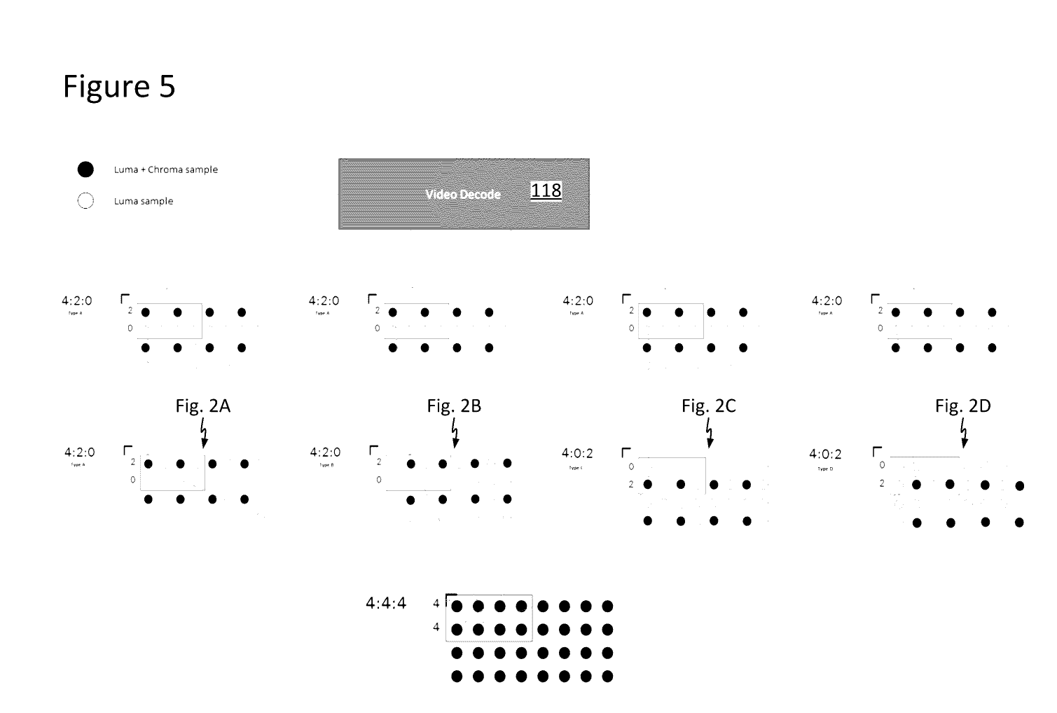

The de-multiplexed video then may undergo decoding 118. In accordance with some embodiments, decoding 118 may be performed via a decoder 592 (discussed below). In some instances, video that has undergone decoding 118 may have previously undergone rearrangement with respect to sampling positions, as discussed above with respect to encoding 106. Thus, it may be desirable to rearrange the decoded video frames to return to the original pre-encoder sampling positions. For instance, consider FIG. 5, which illustrates video decoding of several example YUV 4:2:0 frames for bitstream compliance, in accordance with an embodiment of the present disclosure. Decoder 592 may receive the color information as rearranged via the upstream encoder. Considering the first 2×2 matrix of four sets of luma and chroma samples in FIGS. 2A-2D and FIG. 3, to maintain bitstream compliance, the chroma samples in each of the sub-sampled Types B, C, and D may be treated as being in the (1,1) position as in Type A, although the chroma samples may be from the (1,2), (2,1), and (2,2) positions, respectively. During encoding 106, the difference between each of these chroma sub-samples can be encoded with the chroma sample being only in the (1,1) position in normal YUV 4:2:0 streams. As a result, the encoded bitstream may be transmitted 112 as a single YUV 4:2:0 stream without changing chroma sample positions within this 2×2 matrix of positions.

The decoder 592 may rearrange the received color information to recreate the types of frames (e.g., Types A-D) present before pre-encoder rearrangement. For instance, in the example case of FIG. 5: (1) the first YUV 4:2:0 Type A frame may remain un-rearranged; (2) the second YUV 4:2:0 Type A frame may be rearranged to a YUV 4:2:0 Type B frame; (3) the third YUV 4:2:0 Type A frame may be rearranged to a YUV 4:2:0 Type C frame; and (4) the fourth YUV 4:2:0 Type A frame may be rearranged to a YUV 4:2:0 Type D frame. Thereafter, the four YUV 4:2:0 frames (Types A-D) may be combined to produce a YUV 4:4:4 frame, in accordance with an embodiment.

In accordance with some embodiments, logic at decoder 592 may be used to reposition the chroma samples in their respective positions as per the type (e.g., Types A, B, C, and D) of sub-sampled frame to generate the YUV 4:4:4 frame. For instance, in some cases, decoder 592 may employ logic that orders the frames. In other cases, decoder 592 may employ logic that minimizes (or otherwise reduces) generation of artifacts during scene transitions and video content with more motion. In other cases, however, decoder 592 may not employ such logic. Thus, a YUV 4:2:0 video, for example, would be rendered with the chroma samples in the (1,1) position, as encoded. As such, it may be desirable in such instances to otherwise account for compliance with existing decoders and receivers that do not implement the disclosed techniques.

As will be appreciated in light of this disclosure, the preceding description may be generally applicable to the example case for conversion from YUV 4:2:0 to YUV 4:4:4. The present disclosure is not so limited, however, as in other embodiments, conversion from YUV 4:2:0 to YUV 4:2:2 may be provided, for example. Appropriate scaling may be desired for other kinds of sub-sampled conversion to final YUV 4:2:2 or YUV 4:4:4 frames, in accordance with other embodiments.

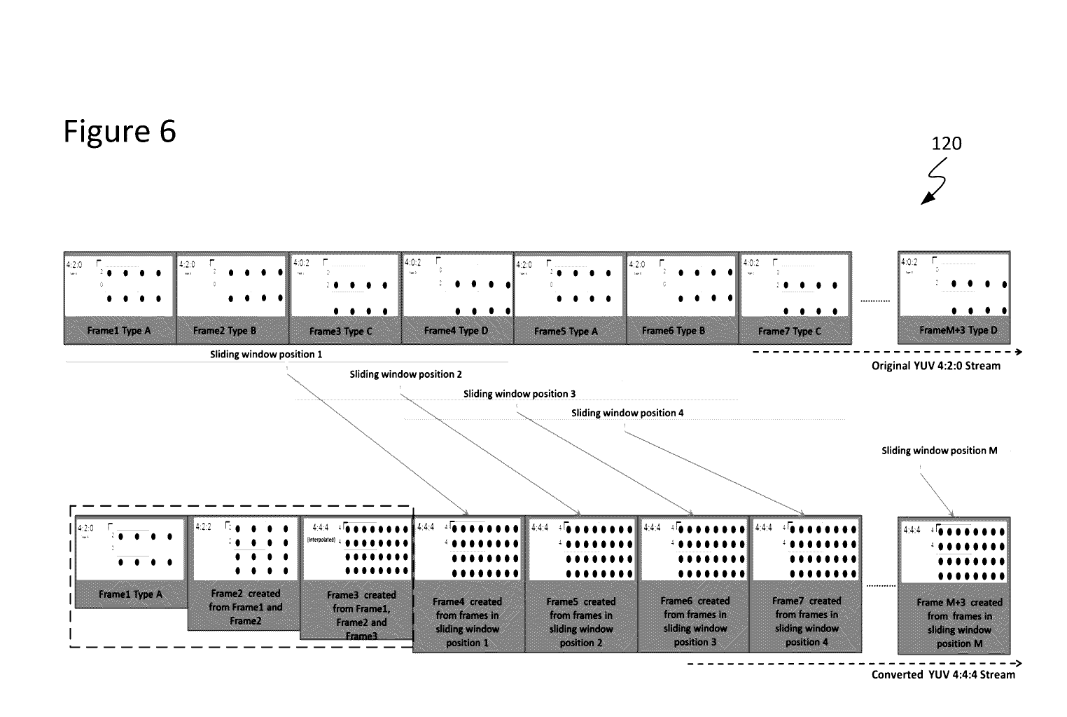

Returning to FIG. 1, after decoding 118, the resultant sub-sampled video data may be combined 120 to create YUV 4:4:4 frame(s) or other frame(s) (e.g., one or more YUV 4:2:2 frames). FIG. 6 illustrates combination of example chroma sub-sampled YUV frames via a sliding window to produce a YUV 4:4:4 sampled frame, in accordance with an embodiment of the present disclosure. The size of the sliding window may be customized, as desired for a given target application or end-use. If converting from YUV 4:2:0 to YUV 4:4:4, for example, the sliding window size may be four frames. If converting from YUV 4:2:2 to YUV 4:4:4, for example, the sliding window size may be two frames. In other cases, larger or smaller sliding window sizes may be utilized, depending on the particular conversion by combination 120.

As will be appreciated in light of this disclosure, with streaming video content at YUV 4:2:0, it may be desirable to buffer the first three frames differently because not all four types of frames may yet be present. For instance, in FIG. 6, only Types A, B, and C are present in the first three frames (enclosed by the dashed rectangular box in the figure). More generally, if N frames are to be utilized for the sampling conversion, then it can be seen that the first N−1 frames in the converted video stream may not contain all color information and thus it may be desirable to deal with them separately. In the example illustrated in FIG. 6, Frame 1 in the converted video stream is the same and equal to Frame 1 in the original sub-sampled video stream. Frame 2 in the converted video stream is a YUV 4:2:2 format frame created by combining the chroma samples in Frame 1 and Frame 2 in the original video stream. Frame 3 in the converted video stream is formed by combining the three sets of chroma samples from Frames 1, 2, and 3. In accordance with an embodiment, the remaining (e.g., fourth) chroma sample set may be interpolated, for example, to form a YUV 4:4:4 frame. Generalizing this, these N−1 frames may be created with the available chroma information as determined best for the target application or end-use utilizing any suitable technique, such as, for example, upsampling by combination to an intermediate chroma format, upsampling by interpolation, or a combination thereof.

Thus, as can be seen, the disclosed techniques may allow the converted video stream to maintain the original frame rate as well as the original bandwidth, in accordance with some embodiments. With existing approaches, transition between frame rates due to changes in content would result in noticeable playback artifacts during the transition. Contrariwise, the disclosed techniques can be used, in accordance with some embodiments, to provide for maintenance of a constant frame rate, thereby minimizing or otherwise reducing the possibility of such artifacts, in some cases.

Using the disclosed techniques, if all luma samples are present in each converted frame as in the original frame (e.g., no combination of luma samples occurs), then changes in scene may change as the original video stream in the luminance domain, in accordance with an embodiment. Thus, as will be appreciated in light of this disclosure, the chrominance domain may require combination of N−1 frames to catch up. However, for slow-moving content or relatively static content with transitions between static scenes, the N−1 frame chroma catch-up would be minimal (or otherwise negligible), in accordance with some embodiments. In the example case of converting YUV 4:2:0 to YUV 4:4:4, N would be 4. In the example case of converting YUV 4:2:2 to YUV 4:4:4, N would be 2.

Returning to FIG. 1, after combination 120, the resultant YUV 4:4:4 frame(s) may undergo conversion 122 to red-green-blue (RGB) frames. In accordance with some embodiments, conversion 122 may be performed via RGB-YUV conversion module 570 (discussed below). The resultant video may be rendered 124 via any suitable video rendering device, such as a display 530 (discussed below). Other suitable means for rendering 124 will depend on a given application and will be apparent in light of this disclosure.

Numerous variations on the processes in the data flow of FIG. 1 will be apparent in light of this disclosure. In some instances, the data flow of FIG. 1 may involve conversion from YUV 4:2:0 to YUV 4:4:4. In some other instances, the data flow of FIG. 1 may involve conversion from YUV 4:2:0 to YUV 4:2:2. As will be appreciated, and in accordance with an embodiment, each of the functional boxes (e.g., 102; 104; 106; 108; 110; 112; 114; 116; 118; 120; 122; 124; 126; 128) shown in that figure can be implemented, for example, as a module or sub-module that, when executed by one or more processors (e.g., such as a processor 520, discussed below) or otherwise operated, causes the associated functionality as described herein to be carried out. The modules/sub-modules may be implemented, for instance, in software (e.g., executable instructions stored on one or more computer readable media), firmware (e.g., embedded routines of a microcontroller or other device which may have I/O capacity for soliciting input from a user and providing responses to user requests), and/or hardware (e.g., gate level logic, field programmable gate array, purpose-built silicon, etc.). Implementations in any one, or combination, of hardware, software, and firmware are possible. In accordance with some embodiments, techniques described herein can be performed, in part or in whole, for example, via a graphics processing unit (GPU), a dedicated graphics card, or an integrated graphics processor (IGP), among others.

Stored Video Content Techniques

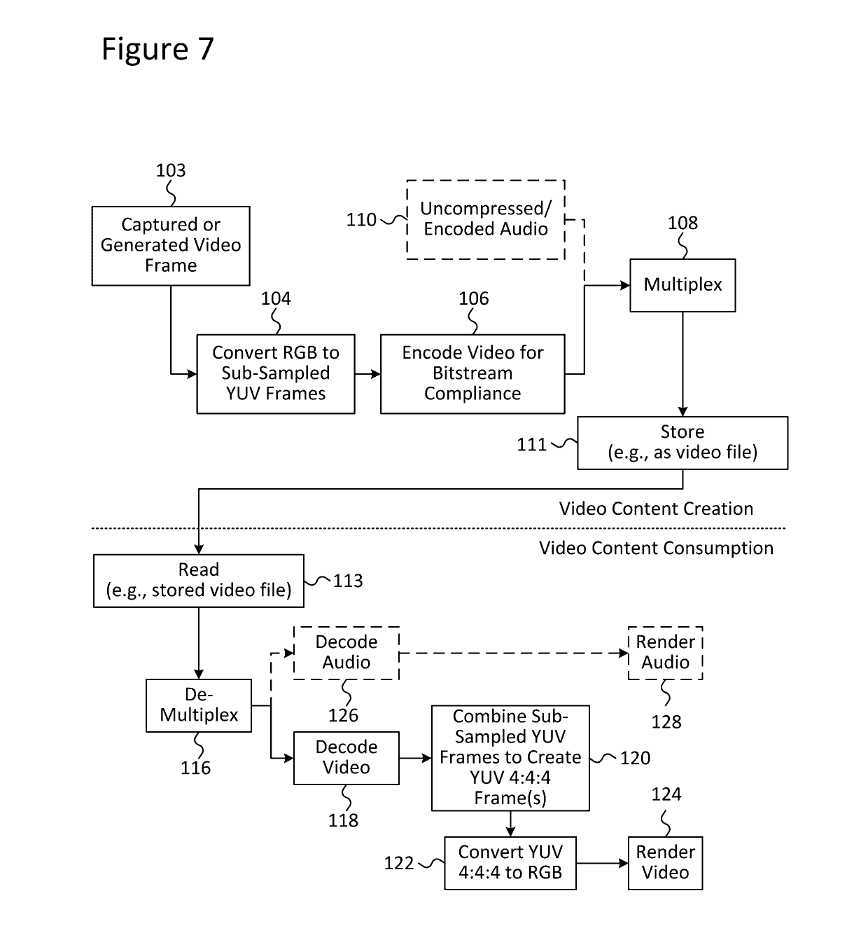

FIG. 7 illustrates an example data flow for stored video content, in accordance with an embodiment of the present disclosure. As can be seen, the portion of the figure above the dotted line generally pertains to the creation (e.g., conversion; encoding; storage) side of stored video content, and the portion of the figure below the dotted line generally pertains to the consumption (e.g., reading; decoding; conversion) side of stored video content. As will be appreciated in light of this disclosure, stored video content creation and consumption may be performed, in part or in whole, via any of the example devices discussed above, for instance, with respect to FIG. 1. In accordance with some embodiments, a computing device 500 (discussed below) may have either or both video creation and consumption capabilities. In an example case, a first portion (e.g., an image capture device 550, discussed below) of a computing device 500 may capture video content used in creating a video file, and a second portion of that computing device 500 may be used in consuming that video file. For instance, an image capture device 550 may be used in creating a YUV 4:2:0 encoded video file, which is then read back to YUV 4:4:4 by computing device 500. In some cases, creation and consumption of video content may occur via a single device or at a single location, whereas in other cases, creation may occur via a first device or at a first location, and consumption may occur via a second device or at a second location. It should be noted, however, that these examples are intended to be non-limiting, as the disclosed techniques can be used in any of a wide range of contexts and applications using any of a wide range of components in any one, or combination, of software, firmware, and hardware, in accordance with some embodiments.

Looking first at the video content creation side of FIG. 7, video data from a captured or generated video frame 103 may undergo conversion 104 from red-green-blue (RGB) frames to sub-sampled YUV frames. In accordance with some embodiments, the video frame 103 may be captured or otherwise generated, for instance, via an image capture device 550 (discussed below) or any other suitable image data source, as desired for a given target application or end-use. In accordance with an embodiment, conversion 104 may be performed, in part or in whole, via an RGB-YUV conversion module 570 (discussed below). Conversion 104 may occur as described above, for instance, with respect to FIGS. 1-6, in accordance with some embodiments. In an example case, the converted YUV frames 104 may be YUV 4:2:0 format. In another example case, the converted YUV frames 104 may be YUV 4:2:2 format. The present disclosure is not so limited, however, as in a more general sense, and in accordance with other embodiments, any suitable sub-sampling format may be utilized, as desired for a given target application or end-use.

After conversion 104, the resultant sub-sampled YUV frames may be encoded 106 for bitstream compliance. In accordance with some embodiments, encoding 106 may be performed, in part or in whole, via an encoder 582 (discussed below). Encoding 106 may occur as described above, for instance, with respect to FIGS. 1-6, in accordance with some embodiments.

The encoded video data 106 then may undergo multiplexing 108. In accordance with some embodiments, multiplexing 108 may be performed, for example, via a multiplexer 584 (discussed below). Multiplexing 108 may occur as described above, for instance, with respect to FIGS. 1-6, in accordance with some embodiments. If uncompressed or encoded audio data is also present, then it optionally may be multiplexed 108 with the encoded video, in accordance with an embodiment.

Thereafter, the resultant multiplexed video (and optionally audio) may be provided for storage 111 as a video file. In accordance with some embodiments, storage 111 may be performed via memory 510 (discussed below) or any other suitable storage device or medium, as desired for a given target application or end-use.

Turning now to the video content consumption side of FIG. 7, video data (e.g., a stored video file) may be read 113 for de-multiplexing 116. In accordance with some embodiments, reading 113 may be performed via a computing device 500 (e.g., via a processor 520, discussed below), a network 400, or other suitable file reading device, as desired for a given target application or end-use.

In accordance with some embodiments, de-multiplexing 116 of the video (and optionally any uncompressed or encoded audio data 110, if present) may be performed via a de-multiplexer 594 (discussed below). In cases where audio data is present, it subsequently may undergo decoding 126 via a decoder 592 (discussed below) and rendering 128 via an audio output device 560 (discussed below). As will be appreciated in light of this disclosure, rendering 128 of audio data may be performed substantially simultaneously with rendering 124 of video data (discussed below).

The de-multiplexed video then may undergo decoding 118. In accordance with some embodiments, decoding 118 may be performed via a decoder 592 (discussed below). Decoding 118 may occur as described above, for instance, with respect to FIGS. 1-6, in accordance with some embodiments. As will be appreciated in light of this disclosure, the preceding description may be generally applicable to the example case for conversion from YUV 4:2:0 to YUV 4:4:4. The present disclosure is not so limited, however, as in other embodiments, conversion from YUV 4:2:0 to YUV 4:2:2 may be provided, for example. Appropriate scaling may be desired for other kinds of sub-sampled conversion to final YUV 4:2:2 or YUV 4:4:4 frames, in accordance with other embodiments.

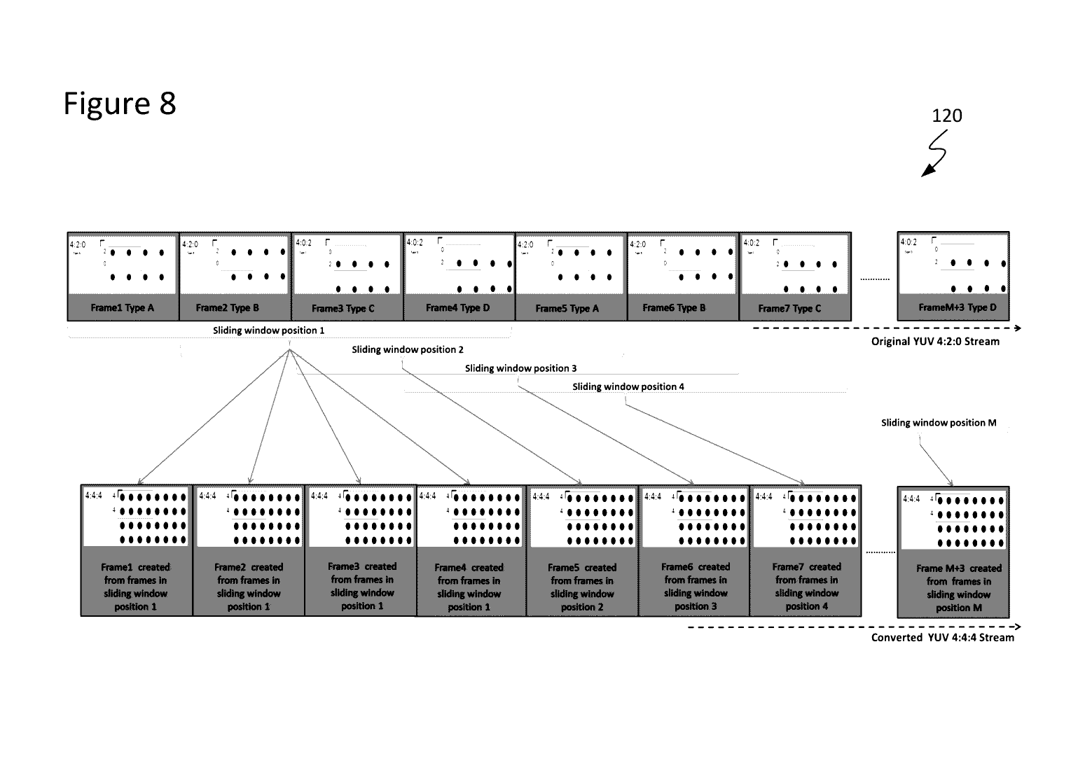

Returning to FIG. 7, after decoding 118, the resultant sub-sampled video data may be combined 120 to create YUV 4:4:4 frame(s) or other frame(s) (e.g., one or more YUV 4:2:2 frames). FIG. 8 illustrates combination of example chroma sub-sampled YUV frames via a sliding window to produce a YUV 4:4:4 sampled frame, in accordance with an embodiment of the present disclosure. The size of the sliding window may be customized, as desired for a given target application or end-use. If converting from YUV 4:2:0 to YUV 4:4:4, for example, the sliding window size may be four frames. If converting from YUV 4:2:2 to YUV 4:4:4, for example, the sliding window size may be two frames. In other cases, larger or smaller sliding window sizes may be utilized, depending on the particular conversion by combination 120.

As will be appreciated in light of this disclosure, with stored video content at YUV 4:2:0, the first N frames (N=4 for YUV 4:2:0 to YUV 4:4:4 conversion) may be created using the same set of four frames in the stored video file. This is possible because these frames would be available in a stored video file, contrary to the case of streaming video content where there would be need to wait for the frames to arrive from the video content source. Thus, as can be seen, the disclosed techniques may allow the converted video file to maintain the original frame rate, in accordance with some embodiments. With existing approaches, transition between frame rates due to changes in content would result in noticeable playback artifacts during the transition. Contrariwise, the disclosed techniques can be used, in accordance with some embodiments, to provide for maintenance of a constant frame rate, thereby minimizing or otherwise reducing the possibility of such artifacts, in some cases.

Returning to FIG. 7, after combination 120, the resultant YUV 4:4:4 frame(s) may undergo conversion 122 to red-green-blue (RGB) frames. In accordance with some embodiments, conversion 122 may be performed via RGB-YUV conversion module 570 (discussed below). The resultant video may be rendered 124 via any suitable video rendering device, such as a display 530 (discussed below). Other suitable means for rendering 124 will depend on a given application and will be apparent in light of this disclosure.

Numerous variations on the processes in the data flow of FIG. 7 will be apparent in light of this disclosure. In some instances, the data flow of FIG. 7 may involve conversion from YUV 4:2:0 to YUV 4:4:4. In some other instances, the data flow of FIG. 7 may involve conversion from YUV 4:2:0 to YUV 4:2:2. As will be appreciated, and in accordance with an embodiment, each of the functional boxes (e.g., 103; 104; 106; 108; 110; 111; 113; 116; 118; 120; 122; 124; 126; 128) shown in that figure can be implemented, for example, as a module or sub-module that, when executed by one or more processors (e.g., such as a processor 520, discussed below) or otherwise operated, causes the associated functionality as described herein to be carried out. The modules/sub-modules may be implemented, for instance, in software (e.g., executable instructions stored on one or more computer readable media), firmware (e.g., embedded routines of a microcontroller or other device which may have I/O capacity for soliciting input from a user and providing responses to user requests), and/or hardware (e.g., gate level logic, field programmable gate array, purpose-built silicon, etc.). Implementations in any one, or combination, of hardware, software, and firmware are possible. In accordance with some embodiments, techniques described herein can be performed, in part or in whole, for example, via a graphics processing unit (GPU), a dedicated graphics card, or an integrated graphics processor (IGP), among others.

System Architecture and Operation

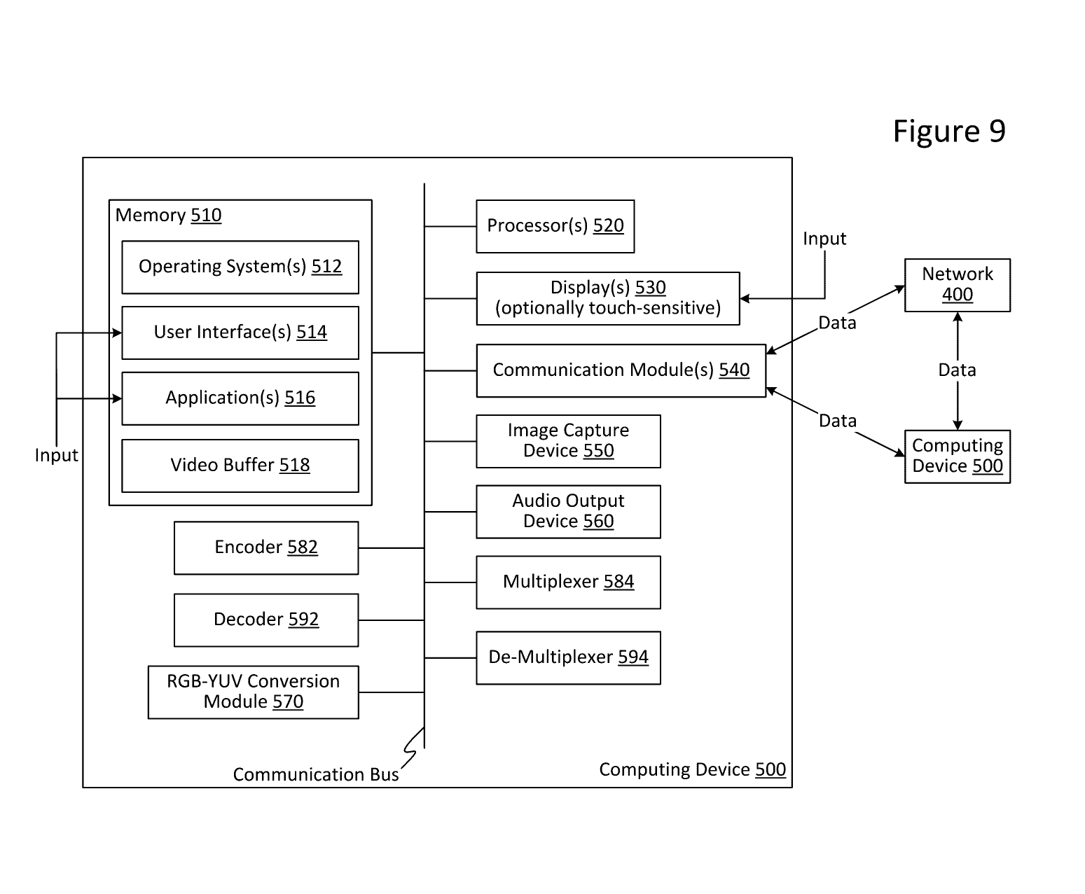

FIG. 9 is a block diagram illustrating an example computing device 500 configured in accordance with an embodiment of the present disclosure. Computing device 500 may be any one, or combination, of a laptop/notebook computer, a sub-notebook computer, a tablet computer, a desktop computer, a mobile phone, a smartphone, a personal digital assistant (PDA), a portable media player (PMP), a cellular handset, a handheld gaming device, a gaming platform, a television set, a computer monitor, and a video conferencing system. Computing device 500 may be configured for wired communication via Universal Serial Bus (USB), Ethernet, FireWire, or other wired communicating interfacing, wireless communication via Wi-Fi, Bluetooth, or other wireless communication interfacing, or a combination of any thereof.

Computing device 500 may include or otherwise have access to memory 510, in accordance with some embodiments. Memory 510 can be of any suitable type, such as, for example, random-access memory (RAM), read-only memory (ROM), or a combination thereof, among others. Memory 510 can be implemented with any one, or combination, of volatile and non-volatile memory and may be of any size, as desired for a given target application or end-use. In some cases, memory 510 may be configured for use in storing, on a temporary or permanent basis, applications, media, programs, content, or a combination thereof. In some instances, memory 510 may be configured for use as processor workspace for one or more processors 520 (discussed below).

In accordance with some embodiments, memory 510 may have stored therein or otherwise have access to one or more modules, which can be accessed and executed by one or more processors 520 (discussed below). For example, in some cases, memory 510 may have stored therein or otherwise have access to one or more operating systems 512. Operating system(s) 512 can be implemented with any suitable standard, custom, proprietary, or open source operating system, mobile or otherwise, as desired for a given target application or end-use. Examples include Android OS from Google, Inc., iOS from Apple, Inc., BlackBerry OS from BlackBerry Ltd., Windows Phone OS from Microsoft Corp., Palm OS/Garnet OS from Palm, Inc., and Symbian OS, among others. A given operating system 512 may be configured, for example, to aid in processing video data, audio data, or both, in the flow through computing device 500. Other suitable configurations and capabilities for operating system(s) 512 will depend on a given application and will be apparent in light of this disclosure.

In some cases, memory 510 may have stored therein or otherwise have access to one or more user interfaces 514. A given user interface 514 may be implemented in a single location (e.g., solely in memory 510) or in a combination of locations (e.g., in memory 510 and a display 530, discussed below), thereby providing such user interface 514 with a given degree of functional distributedness. In some instances, a given user interface 514 may be configured as a graphical user interface (GUI) that is configured, for example, to aid in carrying out any of the various video content creation and consumption techniques described herein. Other suitable configurations and capabilities for user interface(s) 514 will depend on a given application and will be apparent in light of this disclosure.

In some cases, memory 510 may have stored therein or otherwise have access to one or more applications 516. Computing device 500 may be configured to receive user or other input via a given application 516. In some cases, a given application 516 may be configured, for example, to aid in carrying out any of the various video content creation and consumption techniques described herein.

In some cases, memory 510 may have stored therein or otherwise have access to a video buffer 518. Video buffer 518 may be configured to hold video data before it is sent to display(s) 530 and may be configured as typically done to such end. The size of video buffer 518 can be customized, as desired for a given target application or end-use.

A given module of memory 510 may be implemented in any suitable standard, custom, or proprietary programming language, such as, for example, C, C++, objective C, or JavaScript, among others. In accordance with some embodiments, the module(s) of memory 510 can be encoded, for example, on a computer-readable medium that, when executed by a processor (e.g., such as one or more processors 520, discussed below), carries out any one or more of the functions described herein, in part or in whole. The computer-readable medium may be, for example, a hard drive, a compact disk, a memory stick, a server, or any other suitable non-transitory computer or computing device memory that includes executable instructions, or a plurality or combination of such memories.

Other embodiments can be implemented, for instance, with gate-level logic or an application-specific integrated circuit (ASIC) or chip set, or other such purpose-built logic. Some embodiments can be implemented with a microcontroller having input/output (I/O) capability (e.g., inputs for receiving user inputs; outputs for directing other components) and a number of embedded routines for carrying out device functionality. In a more general sense, a given functional module of memory 510 can be implemented in hardware, software, firmware, or a combination thereof, as desired for a given target application or end-use. Other suitable configurations for memory 510 and any modules, applications, and data thereof will depend on a given application and will be apparent in light of this disclosure.

Computing device 500 may include or otherwise have access to one or more processors 520, in accordance with some embodiments. A given processor 520 may be, for example, a central processing unit (CPU), a graphics processing unit (GPU), or any other suitable processing element, as will be apparent in light of this disclosure. In a general sense, a given processor 520 may be configured to perform a given operation associated with computing device 500. To such ends, a given processor 520 may be configured to access and execute a given module within memory 510 or otherwise accessible to computing device 500 (e.g., via a network 400 or elsewhere). In accordance with some embodiments, a given processor 520 may be configured, for example, to analyze video data received from a video frame buffer 102, a captured or generated video frame 103, or other source and to output data that may be utilized in any one, or combination, of converting 104, encoding 106, multiplexing 108, transmitting 112, receiving 114, storing 111, reading 113, de-multiplexing 116, decoding 118, combining 120, converting 122, rendering 124, decoding 126, and rendering 128. Other suitable configurations for processor(s) 520 will depend on a given application and will be apparent in light of this disclosure.

Computing device 500 may include or otherwise have access to one or more displays 530, in accordance with some embodiments. A given display 530 can be any electronic visual display or other device configured to display or otherwise generate an image (e.g., image, video, text, or other displayable content) there at. In some instances, a given display 530 may be integrated, in part or in whole, with computing device 500, whereas in other instances, it may be a stand-alone component configured to communicate with computing device 500 using any suitable wired or wireless (or both) communication means. In an example case, a given display 530 may be a wireless display (WiDi)-enabled device. In another example case, a given display 530 may be a Miracast-enabled device. A given display 530 optionally may be a touchscreen display or other touch-sensitive surface. In some such cases, a touch-sensitive display 530 may facilitate user interaction with computing device 500 via a given user interface 514 (e.g., GUI) presented by such display 530. Other suitable configurations and capabilities for display(s) 530 will depend on a given application and will be apparent in light of this disclosure.

Computing device 500 may include or otherwise have access to one or more communication modules 540, in accordance with some embodiments. A given communication module 540 may be configured, for example, to allow for communication of information between computing device 500 and an entity external thereto, such as a network 400 or another computing device 500, among others. To such ends, a given communication module 540 may be configured to utilize any suitable standard, custom, or proprietary communication protocols, wired or wireless (or both), as desired for a given target application or end-use. Examples include a Wi-Fi communication protocol, a Bluetooth communication protocol, a near field communication (NFC) protocol, a local area network (LAN)-based communication protocol, a cellular-based communication protocol, an Internet-based communication protocol, and a satellite-based communication protocol, among others. Other suitable configurations and capabilities for communication module(s) 540 will depend on a given application and will be apparent in light of this disclosure.

Computing device 500 may include or otherwise have access to an image capture device 550, in accordance with some embodiments. Image capture device 550 can be any device configured to capture digital images, such as a still camera (e.g., a camera configured to capture still photographs) or a video camera (e.g., a camera configured to capture moving images comprising a plurality of frames). Image capture device 550 may include components such as an optics assembly and an image sensor, which may be configured as typically done, and may be configured to operate using light of any desired portion(s) of the electromagnetic spectrum, such as, for instance, the visible spectrum, infrared (IR) spectrum, and ultraviolet (UV) spectrum, among others. In some instances, image capture device 550 may be integrated, in part or in whole, with computing device 500, whereas in other instances, it may be a stand-alone component configured to communicate with computing device 500 using any suitable wired or wireless (or both) communication means. In some instances, image capture device 550 may be configured to continuously acquire imaging data. Image capture device 550 may output image data to an encoder 582 (discussed below). Other suitable configurations and capabilities for image capture device 550 will depend on a given application and will be apparent in light of this disclosure.

Computing device 500 may include or otherwise have access to an audio output device 560, in accordance with some embodiments. Audio output device 560 can be, for example, a loudspeaker or any other device capable of producing sound from an audio data signal (e.g., such as uncompressed or encoded audio 110, discussed above). Audio output device 560 may be configured, for example, to reproduce sounds local to computing device 500, sounds received from a source external to computing device 500, or both. In some instances, audio output device 560 may be integrated, in part or in whole, with computing device 500, whereas in other instances, it may be a stand-alone component configured to communicate with computing device 500 using any suitable wired or wireless (or both) communication means. Other suitable configurations and capabilities for audio output device 500 will depend on a given application and will be apparent in light of this disclosure.

Computing device 500 may include or otherwise have access to an RGB-YUV conversion module 570, in accordance with some embodiments. RGB-YUV conversion module 570 may be configured to convert from RGB to YUV, from YUV to RGB, or both. To such ends, RGB-YUV conversion module 570 may be configured as typically done. Other suitable configurations and capabilities for RGB-YUV conversion module 570 will depend on a given application and will be apparent in light of this disclosure.

Computing device 500 may include or otherwise have access to any one, or combination, of an encoder 582 and a decoder 592, in accordance with some embodiments. Encoder 582 may be configured to encode video data in preparation for transmission thereof (e.g., in the case of streaming video content), storage thereof (e.g., in the case of stored video content), or both. To that end, encoder 582 may be any suitable standard, custom, or proprietary digital encoder. Decoder 592 may be configured to decode video data received (e.g., in the case of streaming video content), retrieved (e.g., in the case of stored video content), or both. To that end, decoder 592 may be any suitable standard, custom, or proprietary digital decoder. Other suitable configurations for encoder 582 and decoder 592 will depend on a given application and will be apparent in light of this disclosure.

Computing device 500 may include or otherwise have access to any one, or combination, of a multiplexer 584 and a de-multiplexer 594, in accordance with some embodiments. Multiplexer 584 may be configured to multiplex video data (and optionally audio data, if present) in preparation for transmission thereof (e.g., in the case of streaming video content), storage thereof (e.g., in the case of stored video content), or both. To that end, multiplexer 584 may be any suitable digital multiplexer configured as typically done. De-multiplexer 594 may be configured to de-multiplex video data (and optionally audio data, if present) received (e.g., in the case of streaming video content), retrieved (e.g., in the case of stored video content), or both. To that end, de-multiplexer 594 may be any suitable digital de-multiplexer configured as typically done. Other suitable configurations for multiplexer 584 and de-multiplexer 594 will depend on a given application and will be apparent in light of this disclosure.

As previously noted, computing device 500 may be configured to communicate with a network 400. Network 400 can be any suitable public or private communication network and can be peer-to-peer or server-based, as desired. In some cases, network 400 may be a private local area network (LAN) operatively coupled to a wide area network (WAN), such as the Internet. In some cases, network 400 may include any one, or combination, of second-generation (2G), third-generation (3G), and fourth-generation (4G) mobile communication technologies. In some cases, network 400 may include a wireless local area network (WLAN) configured to communicate using any of the example communication protocols discussed above, for instance, with respect to communication module(s) 540 of computing device 500. In some instances, network 400 may include supporting infrastructure and functionalities, such as a server and a service provider, but such elements are not necessary to carry out communication via network 400. Numerous suitable configurations for network 400 will be apparent in light of this disclosure.

### Example Implementation

### Data

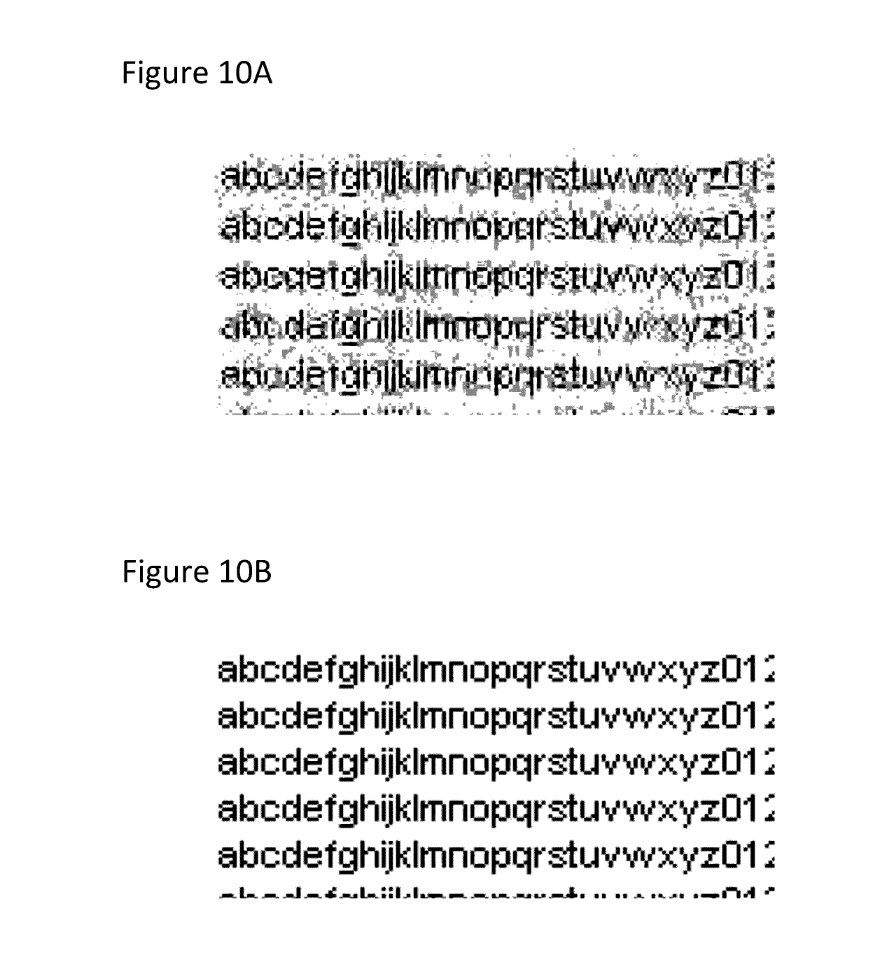

FIG. 10A is an enlarged view of 8-pt. red text on a green background after typical chroma 4:2:0 sub-sampled encoding and decoding. FIG. 10B is an enlarged view of 8-pt. red text on a green background after YUV 4:4:4 conversion by YUV 4:2:0 frame combination encoding and decoding, in accordance with an embodiment of the present disclosure. As can be seen, the text illustrated in FIG. 10A suffers from artifacts, whereas in FIG. 10B, the presence of artifacts in the illustrated text is reduced by about 50-80% (e.g., ±10%). As will be appreciated in light of this disclosure, text improvements realized via use of the disclosed techniques may be relatively more noticeable, for instance, on smaller text sizes, which are generally more susceptible to effects of distortion than larger text sizes, and on colored text rather than black or grayscale text. It should be noted, however, that the disclosed techniques are not intended to be limited to use with text of any particular example size, font, color, or other text-related feature, as in a more general sense, and in accordance with some embodiments, the disclosed techniques can be used to realize improvements with respect to any kind of text in an video content stream or file.

Example System

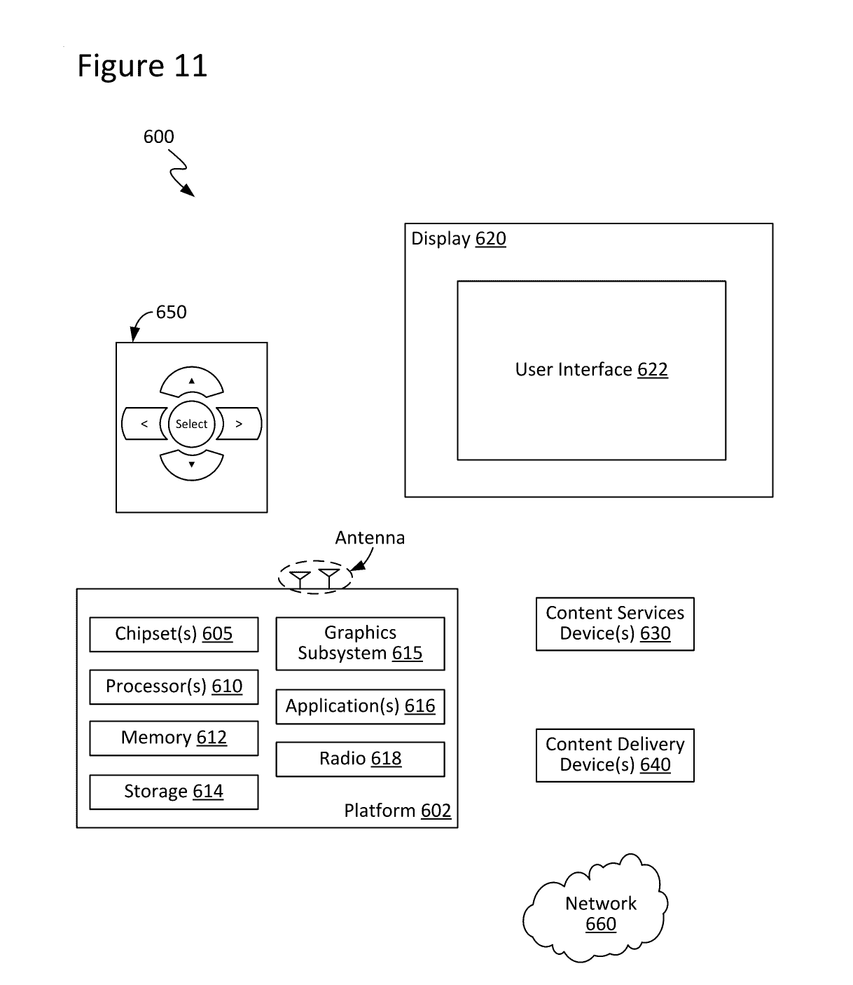

FIG. 11 illustrates an example system 600 that may carry out the techniques for video content creation (e.g., conversion; encoding; transmission) and consumption (e.g., reception; decoding; conversion) as described herein, in accordance with some embodiments. In some embodiments, system 600 may be a media system, although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, set-top box, game console, or other such computing environments capable of performing graphics rendering operations.

In some embodiments, system 600 comprises a platform 602 coupled to a display 620. Platform 602 may receive content from a content device such as content services device(s) 630 or content delivery device(s) 640 or other similar content sources. A navigation controller 650 comprising one or more navigation features may be used to interact, for example, with platform 602 and/or display 620. Each of these example components is described in more detail below.

In some embodiments, platform 602 may comprise any combination of a chipset 605, processor 610, memory 612, storage 614, graphics subsystem 615, applications 616, and/or radio 618. Chipset 605 may provide intercommunication among processor 610, memory 612, storage 614, graphics subsystem 615, applications 616, and/or radio 618. For example, chipset 605 may include a storage adapter (not depicted) capable of providing intercommunication with storage 614.

Processor 610 may be implemented, for example, as Complex Instruction Set Computer (CISC) or Reduced Instruction Set Computer (RISC) processors, x86 instruction set compatible processors, multi-core, or any other microprocessor or central processing unit (CPU). In some embodiments, processor 610 may comprise dual-core processor(s), dual-core mobile processor(s), and so forth. Memory 612 may be implemented, for instance, as a volatile memory device such as, but not limited to, a Random Access Memory (RAM), Dynamic Random Access Memory (DRAM), or Static RAM (SRAM). Storage 614 may be implemented, for example, as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, storage 614 may comprise technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface (HDMI), DisplayPort, wireless HDMI, and/or wireless HD compliant techniques. Graphics subsystem 615 could be integrated into processor 610 or chipset 605. Graphics subsystem 615 could be a stand-alone card communicatively coupled to chipset 605. The techniques for video content creation and consumption described herein may be implemented in various hardware architectures. For example, the techniques for video content creation and consumption as provided herein may be integrated within a graphics and/or video chipset. Alternatively, a discrete security processor may be used. In still another embodiment, the graphics and/or video functions including the techniques for video content creation and consumption may be implemented by a general purpose processor, including a multi-core processor.

Radio 618 may include one or more radios capable of transmitting and receiving signals using various suitable wireless communications techniques. Such techniques may involve communications across one or more wireless networks. Exemplary wireless networks may include, but are not limited to, wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In some embodiments, display 620 may comprise any television or computer-type monitor or display. Display 620 may comprise, for example, a liquid crystal display (LCD) screen, electrophoretic display (EPD) or liquid paper display, flat panel display, touchscreen display, television-like device, and/or a television. Display 620 may be digital and/or analog. In some embodiments, display 620 may be a holographic or three-dimensional (3-D) display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display a user interface 622 on display 620.

In some embodiments, content services device(s) 630 may be hosted by any national, international, and/or independent service and thus may be accessible to platform 602 via the Internet or other network, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620. In some embodiments, content services device(s) 630 may comprise a cable television box, personal computer (PC), network, telephone, Internet-enabled devices or appliance capable of delivering digital information and/or content, and any other similar device capable of unidirectionally or bi-directionally communicating content between content providers and platform 602 and/or display 620, via network 660 or directly. It will be appreciated that the content may be communicated unidirectionally and/or bi-directionally to and from any one of the components in system 600 and a content provider via network 660. Examples of content may include any media information including, for example, video, music, graphics, text, medical and gaming content, and so forth.

Content services device(s) 630 receives content such as cable television programming including media information, digital information, and/or other content. Examples of content providers may include any cable or satellite television or radio or Internet content providers. The provided examples are not meant to limit the present disclosure. In some embodiments, platform 602 may receive control signals from navigation controller 650 having one or more navigation features. The navigation features of controller 650 may be used to interact with user interface 622, for example. In some embodiments, navigation controller 650 may be a pointing device that may be a computer hardware component (specifically human interface device) that allows a user to input spatial (e.g., continuous and multi-dimensional) data into a computer. Many systems such as graphical user interfaces (GUI) and televisions and monitors allow the user to control and provide data to the computer or television using physical gestures.

Movements of the navigation features of controller 650 may be echoed on a display (e.g., display 620) by movements of a pointer, cursor, focus ring, or other visual indicators displayed on the display. For example, under the control of software applications 716, the navigation features located on navigation controller 650 may be mapped to virtual navigation features displayed on user interface 622, for example. In some embodiments, controller 650 may not be a separate component but integrated into platform 602 and/or display 620. Embodiments, however, are not limited to the elements or in the context shown or described herein, as will be appreciated.

In some embodiments, drivers (not shown) may comprise technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 when the platform is turned “off.” In addition, chip set 605 may comprise hardware and/or software support for 5.1 surround sound audio and/or high definition 7.1 surround sound audio, for example. Drivers may include a graphics driver for integrated graphics platforms. In some embodiments, the graphics driver may comprise a peripheral component interconnect (PCI) express graphics card.

In various embodiments, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the radio frequency (RF) spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, email or text messages, voice mail message, alphanumeric symbols, graphics, image, video, text and so forth. Control information may refer to any data representing commands, instructions, or control words meant for an automated system. For example, control information may be used to route media information through a system or instruct a node to process the media information in a predetermined manner (e.g., using the techniques for video content creation and consumption as described herein). The embodiments, however, are not limited to the elements or context shown or described in FIG. 11.

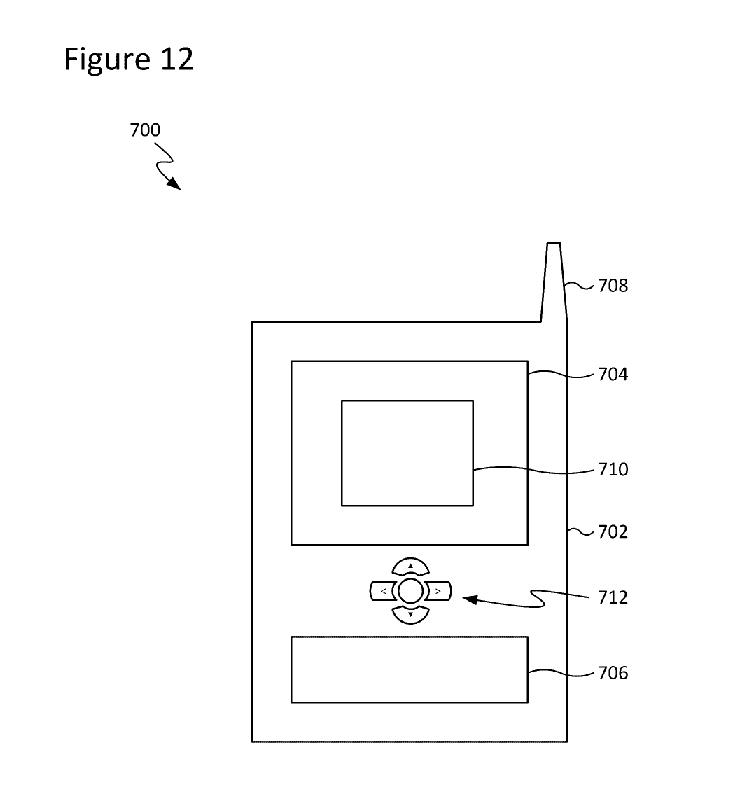

As described above, system 600 may be embodied in varying physical styles or form factors. FIG. 12 illustrates embodiments of a small form factor device 700 in which system 600 may be embodied. In some embodiments, for example, device 700 may be implemented as a mobile computing device having wireless capabilities. A mobile computing device may refer to any device having a processing system and a mobile power source or supply, such as one or more batteries, for example.

As previously described, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, device 700 may comprise a housing 702, a display 704, an input/output (I/O) device 706, and an antenna 708. Device 700 may include a user interface (UI) 710. Device 700 also may comprise navigation features 712. Display 704 may comprise any suitable display unit for displaying information appropriate for a mobile computing device. I/O device 706 may comprise any suitable I/O device for entering information into a mobile computing device. Examples for I/O device 706 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits (IC), application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Whether hardware elements and/or software elements are used may vary from one embodiment to the next in accordance with any number of factors, such as desired computational rate, power levels, heat tolerances, processing cycle budget, input data rates, output data rates, memory resources, data bus speeds, and other design or performance constraints.

Some embodiments may be implemented, for example, using a machine-readable medium or article which may store an instruction or a set of instructions that, if executed by a machine, may cause the machine to perform a method and/or operations in accordance with an embodiment. Such a machine may include, for example, any suitable processing platform, computing platform, computing device, processing device, computing system, processing system, computer, processor, or the like, and may be implemented using any suitable combination of hardware and software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of executable code implemented using any suitable high-level, low-level, object-oriented, visual, compiled, and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers, or other such information storage, transmission, or displays. The embodiments are not limited in this context.

### Further Example Embodiments

The following examples pertain to further embodiments, from which numerous permutations and configurations will be apparent.

Example 1 is a computing device including: a memory; a processor configured to access the memory; a conversion module configured to at least one of: convert a first video frame to a plurality of sub-sampled video frames, each sub-sampled video frame of a first sub-sampled color format, wherein the sub-sampled video frames individually include only partial color information of the first video frame, but, in the aggregate over a series of consecutive sub-sampled video frames, include all color information of the first video frame; and convert a second video frame, produced by combining a number of the sub-sampled video frames, from a second sub-sampled color format to an original color format of the first video frame; and at least one of: an encoder configured to encode a video from the plurality of sub-sampled video frames; and a decoder configured to decode a video to the plurality of sub-sampled video frames.

Example 2 includes the subject matter of any of Examples 1 and 3-10, wherein the decoder includes logic that repositions chroma samples to their respective positions as per each type of sub-sampled video frame.

Example 3 includes the subject matter of any of Examples 1-2 and 4-10, wherein the decoder includes at least one of: order of frames logic; and logic that reduces generation of artifacts in the video at least one of: during scene transitions; and in scenes involving motion.

Example 4 includes the subject matter of any of Examples 1-3 and 5-10 and further includes a video buffer configured to output the first video frame.

Example 5 includes the subject matter of any of Examples 1-4 and 6-10 and further includes a camera configured to output the first video frame.

Example 6 includes the subject matter of any of Examples 1-5 and 7-10, wherein the video encoded from the plurality of sub-sampled video frames is provided from the memory.

Example 7 includes the subject matter of any of Examples 1-6 and 8-10 and further includes a communication module configured to at least one of transmit and receive the video encoded from the plurality of sub-sampled video frames.

Example 8 includes the subject matter of any of Examples 1-7 and 9-10, wherein the computing device is at least one of WiDi-enabled, Miracast-enabled, and WiDock-enabled.

Example 9 includes the subject matter of any of Examples 1-8 and 10, wherein the conversion module is configured to at least one of: convert the first video frame and all subsequent video frames to the plurality of sub-sampled video frames, each sub-sampled video frame of the first sub-sampled color format, wherein the sub-sampled video frames individually include only partial color information of the first video frame or one of the subsequent video frames, but, in the aggregate over the series of consecutive sub-sampled video frames, include all color information of the first video frame or one of the subsequent video frames; and convert the second video frame, produced by combining the number of the sub-sampled video frames, from the second sub-sampled color format to the original color format of the first video frame or one of the subsequent video frames.

Example 10 is a system including: a computing device configured as described with respect to the subject matter of any of Examples 1-9; and a display configured to wirelessly communicate with the computing device and to render the second video frame.

Example 11 is a method of encoding video content, the method including: converting a first video frame to a plurality of sub-sampled video frames, each sub-sampled video frame of a first sub-sampled color format, wherein the sub-sampled video frames individually include only partial color information of the first video frame, but, in the aggregate over a series of consecutive sub-sampled video frames, include all color information of the first video frame; and encoding the plurality of sub-sampled video frames into a video.

Example 12 includes the subject matter of any of Examples 11 and 13-15 and further includes: rearranging sampling positions of each of the sub-sampled video frames to a single, commonly shared sampling position.

Example 13 includes the subject matter of any of Examples 11-12 and 14-15 and further includes at least one of: transmitting the video as a video stream; and storing the video as a video file.

Example 14 includes the subject matter of any of Examples 11-13 and 15 and further includes: converting the first video frame and all subsequent video frames to the plurality of sub-sampled video frames, each sub-sampled video frame of the first sub-sampled color format, wherein the sub-sampled video frames individually include only partial color information of the first video frame or one of the subsequent video frames, but, in the aggregate over the series of consecutive sub-sampled video frames, include all color information of the first video frame or one of the subsequent video frames; and encoding the plurality of sub-sampled video frames into the video.

Example 15 includes the subject matter of any of Examples 11-14, wherein: the first video frame is of RGB color format; and the first sub-sampled color format is either YUV 4:2:0 or YUV 4:2:2.

Example 16 is a method of decoding video content, the method including: decoding a video into a plurality of sub-sampled video frames, each sub-sampled video frame of a first sub-sampled color format, wherein the sub-sampled video frames individually include only partial color information of a first video frame converted to the plurality of sub-sampled video frames, but, in the aggregate over a series of consecutive sub-sampled video frames, include all color information of the first video frame; and combining the plurality of sub-sampled video frames to produce a second video frame of a second sub-sampled color format.

Example 17 includes the subject matter of any of Examples 16 and 18-26, wherein combining the plurality of sub-sampled video frames involves use of a sliding window in selecting the series of consecutive sub-sampled video frames for combination to produce the second video frame.

Example 18 includes the subject matter of Example 17, wherein the sliding window is sized to select four consecutive sub-sampled video frames.

Example 19 includes the subject matter of Example 17, wherein the sliding window is sized to select two consecutive sub-sampled video frames.

Example 20 includes the subject matter of any of Examples 16-19 and 21-26, wherein combining the plurality of sub-sampled video frames includes at least one of: upsampling to the second sub-sampled color format by combination of at least a first sub-sampled video frame with a second sub-sampled video frame, wherein the second sub-sampled color format is different from the first sub-sampled color format and is an intermediate between the first sub-sampled color format and an original color format of the first video frame; and upsampling to the second sub-sampled color by interpolation.

Example 21 includes the subject matter of any of Examples 16-20 and 22-26 and further includes: rearranging sampling positions of each of the sub-sampled video frames from a single, commonly shared sampling position to sampling positions respectively held by each of the sub-sampled video frames prior to any encoding thereof.

Example 22 includes the subject matter of any of Examples 16-21 and 23-26 and further includes: converting the second video frame from the second sub-sampled color format to an original color format of the first video frame, wherein all luma samples are present in the second video frame as in the first video frame.

Example 23 includes the subject matter of any of Examples 16-22 and 24-26 and further includes: rendering the second video frame via a display, wherein at least one of a frame rate and bandwidth original to the first video frame is maintained while rendering the second video frame.

Example 24 includes the subject matter of any of Examples 16-23 and 25-26 and further includes at least one of: receiving the video as a video stream; and reading the video as a stored video file.

Example 25 includes the subject matter of any of Examples 16-24 and 26 and includes: decoding the video into the plurality of sub-sampled video frames, each sub-sampled video frame of the first sub-sampled color format, wherein the sub-sampled video frames individually include only partial color information of the first video frame or a subsequent video frame converted to the plurality of sub-sampled video frames, but, in the aggregate over the series of consecutive sub-sampled video frames, include all color information of the first video frame or the subsequent video frame; and combining the plurality of sub-sampled video frames to produce the second video frame of the second sub-sampled color format.

Example 26 includes the subject matter of any of Examples 16-25, wherein: the first video frame is of RGB color format; the first sub-sampled color format is either YUV 4:2:0 or YUV 4:2:2; and the second sub-sampled color format is either YUV 4:2:2 or YUV 4:4:4.

Example 27 is a non-transitory computer program product including a plurality of instructions non-transiently encoded thereon that, when executed by one or more processors, cause a process to be carried out. The computer program product may include one or more computer-readable media, such as, for example, a hard drive, compact disk, memory stick, server, cache memory, register memory, random-access memory (RAM), read-only memory (ROM), flash memory, or any suitable non-transitory memory that is encoded with instructions that can be executed by one or more processors, or a plurality or combination of such memories. The process includes: converting a first video frame to a plurality of sub-sampled video frames, each sub-sampled video frame of a first sub-sampled color format, wherein the sub-sampled video frames individually include only partial color information of the first video frame, but, in the aggregate over a series of consecutive sub-sampled video frames, include all color information of the first video frame; and encoding the plurality of sub-sampled video frames into a video.

Example 28 includes the subject matter of any of Examples 27 and 29-31, wherein the process further includes: rearranging sampling positions of each of the sub-sampled video frames to a single, commonly shared sampling position.

Example 29 includes the subject matter of any of Examples 27-28 and 30-31, wherein the process further includes at least one of: transmitting the video as a video stream; and storing the video as a video file.

Example 30 includes the subject matter of any of Examples 27-29 and 31, wherein the process includes: converting the first video frame and all subsequent video frames to the plurality of sub-sampled video frames, each sub-sampled video frame of the first sub-sampled color format, wherein the sub-sampled video frames individually include only partial color information of the first video frame or one of the subsequent video frames, but, in the aggregate over the series of consecutive sub-sampled video frames, include all color information of the first video frame or one of the subsequent video frames; and encoding the plurality of sub-sampled video frames into the video.

Example 31 includes the subject matter of any of Examples 27-30, wherein: the first video frame is of RGB color format; and the first sub-sampled color format is either YUV 4:2:0 or YUV 4:2:2.

Example 32 is a non-transitory computer program product including a plurality of instructions non-transiently encoded thereon that, when executed by one or more processors, cause a process to be carried out. The computer program product may include one or more computer-readable media, such as, for example, a hard drive, compact disk, memory stick, server, cache memory, register memory, random-access memory (RAM), read-only memory (ROM), flash memory, or any suitable non-transitory memory that is encoded with instructions that can be executed by one or more processors, or a plurality or combination of such memories. The process includes: decoding a video into a plurality of sub-sampled video frames, each sub-sampled video frame of a first sub-sampled color format, wherein the sub-sampled video frames individually include only partial color information of a first video frame converted to the plurality of sub-sampled video frames, but, in the aggregate over a series of consecutive sub-sampled video frames, include all color information of the first video frame; and combining the plurality of sub-sampled video frames to produce a second video frame of a second sub-sampled color format.

Example 33 includes the subject matter of any of Examples 32 and 34-42, wherein combining the plurality of sub-sampled video frames involves use of a sliding window in selecting the series of consecutive sub-sampled video frames for combination to produce the second video frame.

Example 34 includes the subject matter of Example 33, wherein the sliding window is sized to select four consecutive sub-sampled video frames.

Example 35 includes the subject matter of Example 33, wherein the sliding window is sized to select two consecutive sub-sampled video frames.

Example 36 includes the subject matter of any of Examples 32-35 and 37-42, wherein combining the plurality of sub-sampled video frames includes at least one of: upsampling to the second sub-sampled color format by combination of at least a first sub-sampled video frame with a second sub-sampled video frame, wherein the second sub-sampled color format is different from the first sub-sampled color format and is an intermediate between the first sub-sampled color format and an original color format of the first video frame; and upsampling to the second sub-sampled color by interpolation.

Example 37 includes the subject matter of any of Examples 32-36 and 38-42, wherein the process further includes: rearranging sampling positions of each of the sub-sampled video frames from a single, commonly shared sampling position to sampling positions respectively held by each of the sub-sampled video frames prior to any encoding thereof.

Example 38 includes the subject matter of any of Examples 32-37 and 39-42, wherein the process further includes: converting the second video frame from the second sub-sampled color format to a color format of the first video frame, wherein all luma samples are present in the second video frame as in the first video frame.

Example 39 includes the subject matter of any of Examples 32-38 and 40-42, wherein the process further includes: rendering the second video frame via a display, wherein at least one of a frame rate and bandwidth original to the first video frame is maintained while rendering the second video frame.

Example 40 includes the subject matter of any of Examples 32-39 and 41-42, wherein the process further includes at least one of: receiving the video as a video stream; and reading the video as a stored video file.

Example 41 includes the subject matter of any of Examples 32-40 and 42, wherein the process includes: decoding the video into the plurality of sub-sampled video frames, each sub-sampled video frame of the first sub-sampled color format, wherein the sub-sampled video frames individually include only partial color information of the first video frame or a subsequent video frame converted to the plurality of sub-sampled video frames, but, in the aggregate over the series of consecutive sub-sampled video frames, include all color information of the first video frame or the subsequent video frame; and combining the plurality of sub-sampled video frames to produce the second video frame of the second sub-sampled color format.

Example 42 includes the subject matter of any of Examples 32-41, wherein the first video frame is of RGB color format; the first sub-sampled color format is either YUV 4:2:0 or YUV 4:2:2; and the second sub-sampled color format is either YUV 4:2:2 or YUV 4:4:4.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A computing device comprising:
a memory;
a processor configured to access the memory;
a conversion module configured to at least one of:
convert a first video frame to a plurality of sub-sampled video frames, each sub-sampled video frame of a first sub-sampled color format, wherein the sub-sampled video frames individually include only partial color information of the first video frame, but, in the aggregate over a series of consecutive sub-sampled video frames, include all color information of the first video frame; and
convert a second video frame, produced by combining a number of the sub-sampled video frames, from a second sub-sampled color format to an original color format of the first video frame; and
at least one of:
an encoder configured to encode a video from the plurality of sub-sampled video frames; and
a decoder configured to decode a video to the plurality of sub-sampled video frames.

2. The computing device of claim 1, wherein the decoder comprises logic that repositions chroma samples to their respective positions as per each type of sub-sampled video frame.

3. The computing device of claim 1, wherein the decoder comprises at least one of:
order of frames logic; and
logic that reduces generation of artifacts in the video at least one of:
during scene transitions; and
in scenes involving motion.

4. The computing device of claim 1 further comprising a video buffer configured to output the first video frame.

5. The computing device of claim 1 further comprising a camera configured to output the first video frame.

6. The computing device of claim 1, wherein the video encoded from the plurality of sub-sampled video frames is provided from the memory.

7. The computing device of claim 1 further comprising a communication module configured to at least one of transmit and receive the video encoded from the plurality of sub-sampled video frames.

8. The computing device of claim 1, wherein the computing device is at least one of WiDi-enabled, Miracast-enabled, and WiDock-enabled.

9. The computing device of claim 1, wherein the conversion module is configured to at least one of:
convert the first video frame and all subsequent video frames to the plurality of sub-sampled video frames, each sub-sampled video frame of the first sub-sampled color format, wherein the sub-sampled video frames individually include only partial color information of the first video frame or one of the subsequent video frames, but, in the aggregate over the series of consecutive sub-sampled video frames, include all color information of the first video frame or one of the subsequent video frames; and
convert the second video frame, produced by combining the number of the sub-sampled video frames, from the second sub-sampled color format to the original color format of the first video frame or one of the subsequent video frames.

10. A system comprising:
the computing device of claim 1; and
a display configured to wirelessly communicate with the computing device and to render the second video frame.

11. A non-transitory computer program product encoded with instructions that, when executed by one or more processors, causes a process to be carried out, the process comprising:
converting a first video frame to a plurality of sub-sampled video frames, each sub-sampled video frame of a first sub-sampled color format, wherein the sub-sampled video frames individually include only partial color information of the first video frame, but, in the aggregate over a series of consecutive sub-sampled video frames, include all color information of the first video frame; and
encoding the plurality of sub-sampled video frames into a video.

12. The non-transitory computer program product of claim 11, wherein the process further comprises:
rearranging sampling positions of each of the sub-sampled video frames to a single, commonly shared sampling position.

13. The non-transitory computer program product of claim 11, wherein the process further comprises at least one of:
transmitting the video as a video stream; and
storing the video as a video file.

14. The non-transitory computer program product of claim 11, wherein the process comprises:
converting the first video frame and all subsequent video frames to the plurality of sub-sampled video frames, each sub-sampled video frame of the first sub-sampled color format, wherein the sub-sampled video frames individually include only partial color information of the first video frame or one of the subsequent video frames, but, in the aggregate over the series of consecutive sub-sampled video frames, include all color information of the first video frame or one of the subsequent video frames; and
encoding the plurality of sub-sampled video frames into the video.

15. The non-transitory computer program product of claim 11, wherein:
the first video frame is of RGB color format; and
the first sub-sampled color format is either YUV 4:2:0 or YUV 4:2:2.

16. A non-transitory computer program product encoded with instructions that, when executed by one or more processors, causes a process to be carried out, the process comprising:
decoding a video into a plurality of sub-sampled video frames, each sub-sampled video frame of a first sub-sampled color format, wherein the sub-sampled video frames individually include only partial color information of a first video frame converted to the plurality of sub-sampled video frames, but, in the aggregate over a series of consecutive sub-sampled video frames, include all color information of the first video frame; and
combining the plurality of sub-sampled video frames to produce a second video frame of a second sub-sampled color format.

17. The non-transitory computer program product of claim 16, wherein combining the plurality of sub-sampled video frames involves use of a sliding window in selecting the series of consecutive sub-sampled video frames for combination to produce the second video frame.

18. The non-transitory computer program product of claim 17, wherein the sliding window is sized to select either two or four consecutive sub-sampled video frames.

19. The non-transitory computer program product of claim 16, wherein combining the plurality of sub-sampled video frames comprises at least one of:
upsampling to the second sub-sampled color format by combination of at least a first sub-sampled video frame with a second sub-sampled video frame, wherein the second sub-sampled color format is different from the first sub-sampled color format and is an intermediate between the first sub-sampled color format and an original color format of the first video frame; and
upsampling to the second sub-sampled color by interpolation.

20. The non-transitory computer program product of claim 16, wherein the process further comprises:
rearranging sampling positions of each of the sub-sampled video frames from a single, commonly shared sampling position to sampling positions respectively held by each of the sub-sampled video frames prior to any encoding thereof.

21. The non-transitory computer program product of claim 16, wherein the process further comprises:
converting the second video frame from the second sub-sampled color format to a color format of the first video frame, wherein all luma samples are present in the second video frame as in the first video frame.

22. The non-transitory computer program product of claim 16, wherein the process further comprises:
rendering the second video frame via a display, wherein at least one of a frame rate and bandwidth original to the first video frame is maintained while rendering the second video frame.

23. The non-transitory computer program product of claim 16, wherein the process further comprises at least one of:
receiving the video as a video stream; and
reading the video as a stored video file.

24. The non-transitory computer program product of claim 16, wherein the process comprises:
decoding the video into the plurality of sub-sampled video frames, each sub-sampled video frame of the first sub-sampled color format, wherein the sub-sampled video frames individually include only partial color information of the first video frame or a subsequent video frame converted to the plurality of sub-sampled video frames, but, in the aggregate over the series of consecutive sub-sampled video frames, include all color information of the first video frame or the subsequent video frame; and
combining the plurality of sub-sampled video frames to produce the second video frame of the second sub-sampled color format.

25. The non-transitory computer program product of claim 16, wherein:
the first video frame is of RGB color format;
the first sub-sampled color format is either YUV 4:2:0 or YUV 4:2:2; and
the second sub-sampled color format is either YUV 4:2:2 or YUV 4:4:4.
